(19) United States
(12) Patent Application Publication
(10) Pub. No.: US 2026/0260526 A1
(43) Pub. Date: Sep. 3, 2026

(54) SYSTEMS, METHODS, AND APPARATUSES FOR VEHICLE DIAGNOSTICS

(71) Applicant: Remotech Inc., Valencia, CA (US)

(72) Inventors: Gregor Greg Arustamyan, Northridge, CA (US); Sam Sarkis Roupen, Van Nuys, CA (US); Ambartsum Muradyan, North Hollywood, CA (US)

(73) Assignee: Remotech Inc., Valencia, CA (US)

(21) Appl. No.: 19/547,305

(22) Filed: Feb. 23, 2026

Related U.S. Application Data
(60) Provisional application No. 63/765,733, filed on Mar. 2, 2025.

(51) Int. Cl. G07C 5/08; G07C 5/00

(52) U.S. Cl. CPC G07C 5/0816; G07C 5/008; G07C 5/085

(57) ABSTRACT

A vehicle diagnostic apparatus is provided. The vehicle diagnostic apparatus can include a transceiver in communication with an engine control unit (ECU). The transceiver can receive signals from the ECU that include parameter group numbers (PGNs). Additionally, the vehicle diagnostic apparatus can include a processor in communication with the transceiver. The processor can extract suspect parameter numbers (SPNs) from PGNs and compare them with historical SPNs stored in a database to determine a parameter type, fault severity, operation threshold, or any combination thereof. The processor can also generate an alert when a diagnostic trouble code (DTC) is detected based on the comparison, transmit the alert via the transceiver to a remote device, receive instructions from the remote device via the transceiver to clear the DTC, and clear the DTC when operating criteria are satisfied. The processor can communicate with a remote device to receive diagnostic results and commands.

### CROSS-REFERENCE TO RELATED APPLICATIONS

This application claims the benefit of U.S. Ser. No. 63/765,733, filed on Mar. 2, 2025, the entirety of which is incorporated by reference.

### BACKGROUND

### Technical Field

The technical field of the present disclosure relates to diagnostics, troubleshooting, and monitoring of automobiles and, more particularly, to managing and maintaining the operation of heavy-duty trucks.

### Description of Related Art

Conventional vehicle diagnostic tools are limited in scope, often requiring physical access, lacking tamper-proof data integrity, and offering minimal integration with fleet management or predictive maintenance systems. Current telematics devices may record position or basic metrics but do not integrate deeply with diagnostic functions such as emissions compliance, regeneration events, have the capability to send commands to the vehicle engine control unit (ECU) through cellular communication from a remote device, or predictive failure analysis. There is a need for a comprehensive, secure, and extensible diagnostic platform capable of both local and cloud-based operations, with modular adaptability to future technologies.

### BRIEF SUMMARY

This summary provides a discussion of aspects of certain embodiments of the invention. It is not intended to limit the claimed invention or any of the terms in the claims. The summary provides some aspects, but there are other aspects and embodiments of the invention that are not discussed here.

In one aspect, a vehicle diagnostic apparatus is provided. The vehicle diagnostic apparatus can include a transceiver in communication with an engine control unit (ECU) of a vehicle. The transceiver can receive signals from the ECU that include parameter group numbers (PGNs). Additionally, the vehicle diagnostic apparatus can include a processor in communication with the transceiver. The processor can be configured to extract suspect parameter numbers (SPNs) from the PGNs, compare the extracted SPNs with historical SPNs stored in a database to determine a parameter type, fault severity, operation threshold, or any combination thereof. The processor can also generate an alert when a diagnostic trouble code (DTC) is detected based on the comparison, transmit the alert via the transceiver to a remote device, receive instructions from the remote device via the transceiver to clear the DTC, and clear the DTC when one or more operating criteria are satisfied.

In one embodiment, code clearing, filter resets, forced regeneration, data monitoring, or any combination thereof can be performed by the remote device. The communication between the remote device and the transceiver can be via cellular communication.

In one embodiment, the one or more operating criteria is satisfied when a speed of the vehicle is 0 miles per hour. Additionally, or alternatively, the one or more operating criteria is satisfied when the vehicle is in a Key On Engine Off (KOEO) state and the engine RPM is 0. Additionally, or alternatively, the one or more operating criteria is satisfied when the instruction to clear the DTC is received at least 30 minutes after a previous instruction to clear a DTC. Additionally, or alternatively, the one or more operating criteria is satisfied when the instruction to clear the DTC is less than a threshold number within a predefined time period. Additionally, or alternatively, the one or more operating criteria is satisfied when an emissions safety threshold is not exceeded.

In another embodiment, the transceiver can communicate with the remote device via a short-range wireless network or a cellular network.

In another embodiment, the vehicle diagnostic apparatus can include a global positioning system (GPS) module in communication with the processor. The processor can log a location of the vehicle diagnostic apparatus upon receiving the instruction from the remote device or clearing the DTC.

In another embodiment, the processor can be further configured to perform one or more diagnostic tests based on the signals received from the ECU. The transmission between the processor and the remote device can be via a cellular network.

In another embodiment, the processor can be further configured to transmit the PGNs and extracted SPNs to the remote device, and the processor can receive results from one or more diagnostic tests performed by the remote device and one or more commands associated with the results.

In another aspect, a method for diagnosing and clearing a diagnostic trouble code (DTC) is provided. The method can include receiving signals from an engine control unit (ECU) of a vehicle at a processor via a transceiver, where the signals comprise parameter group numbers (PGNs). The processor can extract suspect parameter numbers (SPNs) from the PGNs and compare the extracted SPNs with historical SPNs stored in a database to determine a parameter type, fault severity, operation threshold, or any combination thereof. The processor can generate an alert when a diagnostic trouble code (DTC) is detected based on the comparison and transmit the extracted SPNs and the alert to a remote device via the transceiver. The remote device can diagnose vehicle issues based on at least the extracted SPNs. The transceiver can receive an instruction from the remote device to clear the DTC, and the processor can clear the DTC once one or more operating criteria are satisfied.

The processor can generate an alert when a DTC is detected and notify the user. A detailed diagnostic breakdown can be generated and displayed for the detected alerts. The remote device can generate and display the detailed diagnostic breakdown. Alternatively, the processor can generate the detailed diagnostic breakdown to be displayed for the user.

In one embodiment, the one or more operating criteria are satisfied when a speed of the vehicle is 0 miles per hour. Additionally, or alternatively, the one or more operating criteria are satisfied when the vehicle is in a Key On Engine Off (KOEO) state and the engine RPM is 0. Additionally, or alternatively, the one or more operating criteria are satisfied when the instruction to clear the DTC is received at least 30 minutes after a previous instruction to clear a DTC.

In another embodiment, the transceiver is in communication with the remote device via a short-range wireless network or a cellular network.

In another embodiment, the method also includes logging a location of the vehicle via a global positioning system (GPS) module upon receiving the instruction from the remote device.

In another embodiment, the transmission between the processor and the remote device can be via a cellular network.

In another embodiment, the remote device can utilize artificial intelligence (AI) to diagnose vehicle issues.

In another embodiment, the method also includes transmitting, via the transceiver, the detected DTC to the database.

In another aspect, a system is provided. The system can include a vehicle diagnostic apparatus connected to an engine control unit (ECU) of a vehicle, and one or more processors communicatively coupled with the vehicle diagnostic apparatus and a database. The vehicle diagnostic apparatus can be configured to log parameters and diagnostic events associated with the vehicle, and the one or more processors can be configured to receive logged diagnostic events from the vehicle diagnostic apparatus, compare the logged diagnostic events to historical diagnostic events associated with the vehicle that are stored in the database, and predict one or more system failures based at least in part on the comparison of the logged diagnostic events to the historical diagnostic events associated with the vehicle.

In one embodiment, the logged diagnostic events can include suspect parameter numbers (SPNs) and failure mode identifiers (FMI).

In another embodiment, the comparison of the logged diagnostic events to the historical diagnostic events associated with the vehicle is based at least in part on one or more pattern recognition algorithms.

In another embodiment, the one or more processors can be further configured to generate one or more health scores of the vehicle, a system failure timeline of the vehicle, and/or one or more maintenance recommendations to resolve the one or more predicted system failures. On-board engine diagnostics tests can also be performed via a cellular or Bluetooth connection, enabling the vehicle to exit the road for repair. The one or more processors can be further configured to transmit the one or more maintenance recommendations to the ECU, a remote device, or any combination thereof. Additionally, or alternatively, the one or more processors can be further configured to generate a health certificate for the vehicle based on historical health scores of the vehicle.

In another embodiment, the system can include a trained model communicatively coupled to the one or more processors. The trained model can be configured to detect a change in parameters captured by the ECU. The one or more processors can be further configured to dynamically adjust parameter thresholds based on detected changes in captured parameters.

In another embodiment, the one or more processors can be further configured to display a visualization of the logged diagnostic events and the one or more predicted system failures. The one or more processors can be configured to transmit the logged diagnostic events and the one or more predicted system failures to a remote device for visualization on a graphical user interface.

In another aspect, a device for predicting vehicle failures is provided. The device can include a processor configured to receive vehicle parameters from an engine control unit (ECU) of a vehicle. The vehicle parameters can include parameter group numbers (PGNs). The processor can be configured to derive fault parameters based on the PGNs. The device can also have memory communicatively coupled with the processor, a pattern recognition model stored in the memory, and a communication interface communicatively coupled with the processor. The pattern recognition model can be configured to enable the processor to perform pattern recognition processing of the fault parameters derived from the PGNs, thereby detecting and classifying patterns in the vehicle parameters indicative of one or more faults within the vehicle. The processor can be configured to transmit a signal via the communication interface when one or more patterns are indicative of one or more faults within the vehicle, store the fault parameters derived from the PGNs in a log when the fault parameters are indicative of one or more faults within the vehicle, and analyze the log with a machine learning algorithm at predetermined intervals to generate an updated pattern recognition model.

In one embodiment, the pattern recognition model can be a pre-trained model enabling detection of abnormal behavior based on the PGNs.

In another embodiment, the log can be further processed to detect changes over time and capture changes in the health of the vehicle.

In another embodiment, the processor can be configured to transmit the signal to a remote device. Additionally, or alternatively, the processor can be configured to transmit the signal to the ECU.

In another embodiment, the processor, memory, and communication interface can be located in a local device in the vehicle.

In another embodiment, the processor, memory, and communication interface are located in a remote device from the vehicle.

In another embodiment, the step of analyzing the log with the machine learning algorithm can be performed by transmitting the log to a server via the communication interface and receiving the updated pattern recognition model from the server.

### BRIEF DESCRIPTION OF THE DRAWINGS

The preceding aspects and many of the attendant advantages of the present technology will become more readily appreciated by reference to the following Detailed Description when taken in conjunction with the accompanying simplified drawings of example embodiments. The drawings briefly described below are presented for ease of explanation and do not limit the scope of the claimed subject matter.

FIG. 1 depicts a simplified block diagram of an embodiment of a system for diagnosing trouble codes in a vehicle.

FIG. 2 depicts a simplified diagram of an implementation of a diagnostic apparatus in a vehicle.

FIG. 3 depicts a flow chart of an embodiment of a process for diagnosing and clearing diagnostic trouble codes.

FIG. 4 depicts a simplified block diagram of an embodiment of a system for managing diagnostics of vehicles in a fleet.

### DETAILED DESCRIPTION

The present disclosure involves systems and methods that allow for diagnosing and clearing diagnostic trouble codes in a vehicle. As described herein, the present disclosure enables users to identify diagnostic issues in vehicles in operation and to clear diagnostic trouble codes. The present disclosure also provides for monitoring and predictive analytics, reducing downtime and unnecessary service visits. The present disclosure also allows detecting abnormal parameter drift and predicting failures using vehicle parameter patterns, improving fleet reliability and reducing unexpected breakdowns. System updates can optimize diagnostic alerts based on historical fleet data. The present disclosure also provides real-time visibility into vehicle health, fault codes, emissions status, and actionable recommendations.

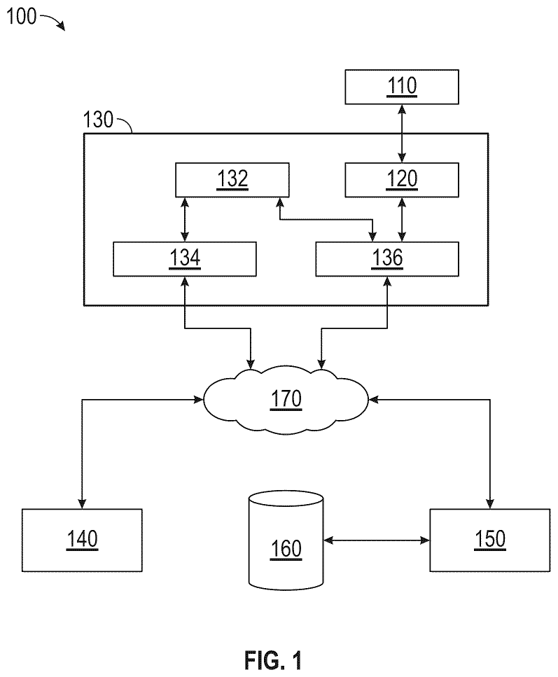

Turning to FIG. 1, a simplified block diagram of an embodiment of a system 100 for diagnosing trouble codes in a vehicle is illustrated. The system includes an engine control unit (ECU) 110 of a vehicle (not illustrated). The ECU 110 is communicatively coupled to the processor 132 of a vehicle diagnostic apparatus 130 via a CAN transceiver 120. The ECU 110 is configured to receive vehicle data or parameter group numbers (PGNs) from sensors installed in the vehicle. The ECU 110 manages the PGNs, diagnostic trouble codes (DTCs), suspect parameter numbers (SPNs), and failure mode identifiers (FMIs). The ECU 110 also controls the execution of functions, such as, among other things, clearing DTCs. The ECU 110 also controls the malfunction indicator lamp (MIL) on the vehicle and emissions readiness status based on internal monitoring and regulatory rules. The ECU 110 can have a J1939 port and can be connected to the transceiver 120 via, for example, a 9-pin male connector. The system 100 can log every diagnostic event, including DTC reads, clears, or regeneration requests, with associated metadata such as timestamps, GPS location, and user identity. Logs may be cryptographically signed to ensure tamper-proof integrity. The vehicle diagnostic apparatus 130 can act as a vehicle black box, capturing the last known operating parameters in the event of a crash or system failure. The vehicle diagnostic apparatus 130 can also provide fleet management capabilities, including driver behavior monitoring or remote diagnostics. The vehicle diagnostic apparatus 130 can also provide emissions compliance verification, including monitoring of DPF, DEF, and SCR systems. The vehicle diagnostic apparatus 130 can also provide automatic pre-trip and post-trip inspections with DTC capture. The vehicle diagnostic apparatus 130 can also generate vehicle health certificates for resale or inspection events.

The processor 132 of the vehicle diagnostic apparatus 130 can be configured to receive the vehicle data (e.g., PGNs) from the ECU 110 for diagnostic assessment. The Global Positioning System (GPS) module 134 is communicatively coupled to the processor 132 and is configured to track the vehicle's location. In at least one embodiment, the GPS module 134 continuously captures the vehicle's location, which can be transmitted to a remote device 140 and/or server 150 to provide real-time location data of the vehicle. Additionally, the GPS module 134 can provide a location (or GPS coordinates) and a timestamp, which are logged with a diagnostic event. When utilized with a network or fleet of other vehicles in the system 100, the GPS module 134 can provide location data along with diagnostic information to a dashboard on a remote device 140, server 150, or both for fleet-level monitoring. The GPS module 134 can also enable geofencing and route-based analytics when combined with detected fault data. The GPS module 134 can transmit the captured locations via the network 170.

The communication interface 136 is communicatively coupled with the processor 132 and is configured to transmit and receive information to a remote device 140, server 150, or both via a network 170. In at least one embodiment, the communication interface 136 is a cellular module that transmits and receives information through a cellular network. Alternatively, the communication interface 136 is a wireless internet module that transmits and receives information through an internet network.

The remote device 140 can be a mobile device (e.g., cell phone, tablet, laptop) that enables the end user to monitor the diagnostics and send commands to the vehicle. The server 150 can be a backend computer that can be configured for data aggregation and synchronization. For example, the server 150 can be configured to receive diagnostic data, fault codes, emissions status, and event logs from one or more vehicles. The server 150 can synchronize logs that include timestamps, GPS location, engine states, user identity, and ECU acknowledgments. The server 150 can also be configured for system-wide or fleet-level monitoring. For example, the server 150 can provide a dashboard interface for fleet managers to view real-time health metrics across vehicles, track fault timelines correlated with GPS location, and monitor emissions compliance status and readiness indicators. The server 150 can also enforce multi-tiered user roles (driver, mechanic, fleet manager, administrator), control permissions for sensitive actions (e.g., remote code clearing, regeneration initiation), and implement authentication mechanisms for critical operations. The server 150 can also provide predictive analytics and artificial intelligence (AI) integration. For example, the server 150 can process historical SPN/FMI patterns to detect abnormal parameter drift, generate predictive maintenance recommendations and health scores for vehicles/fleets, and dynamically adjust diagnostic thresholds and alert priorities based on fleet-wide data. The server 150 can also provide over-the-air (OTA) update management for the vehicle diagnostic apparatus 130. The server can host firmware and configure update packages, authenticate update requests and enforce role-based access control, support fail-safe rollback for corrupted or incomplete updates, and update critical parameter blocklists, emissions thresholds, and diagnostic rules remotely. The server 150 can communicatively couple to one or more databases 160 for diagnostics, code-clearing, OTA configuration, analytics, and auditability.

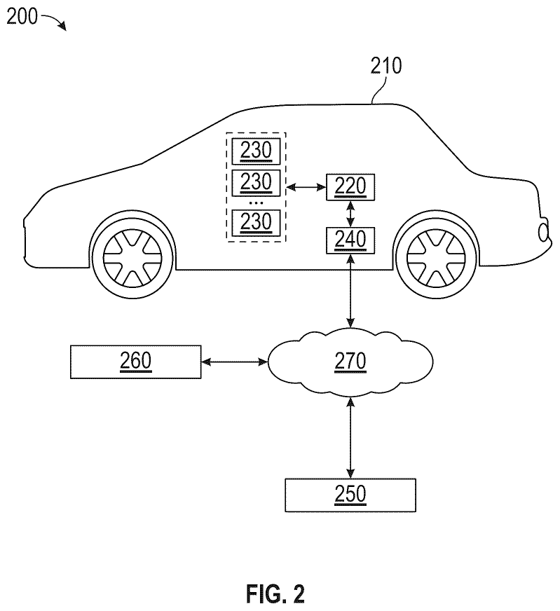

Turning to FIG. 2, a simplified diagram of an implementation 200 of a diagnostic apparatus in a vehicle is illustrated. The implementation 200 includes a vehicle 210 that has a plurality of sensors 230, which are communicatively coupled to the vehicle's ECU 220. A vehicle diagnostic apparatus 240 is installed in the vehicle 210 and is connected to the ECU. The vehicle diagnostic apparatus 240 can be configured to communicate with the server 250 and one or more remote devices 260 via a network 270. The plurality of sensors 230 can include an engine speed sensor, which captures the engine revolutions per minute and can be used to determine whether the engine is idle or active. The plurality of sensors 230 can also include a vehicle speed sensor that measures wheel and/or transmission speed, which can be used to determine whether the vehicle is moving. The plurality of sensors 230 can also include a coolant temperature sensor that monitors the engine thermal state, which can be used to prevent clearing or regeneration if not at an acceptable level (e.g., overheating or below operating temperature). The plurality of sensors 230 can also include an oil pressure sensor that monitors lubrication health, which can indicate that a clearing is blocked if oil pressure is abnormal and can also mask engine faults. The plurality of sensors 230 can also include diesel particulate filter (DPF) sensors, which can include soot level sensors and/or temperature sensors. The soot level sensors indicate particulate accumulation, and the temperature sensors can be used to validate regeneration conditions and detect thermal anomalies. The plurality of sensors 230 can also include diesel exhaust fluid (DEF) level sensors, which monitor the selective catalytic reduction (SCR) system readiness. The plurality of sensors 230 can also include SCR efficiency sensors that measure NOx conversion efficiency and ensure emissions compliance before clearing. The plurality of sensors 230 can also include boost pressure sensors that detect turbocharged or fuel system issues. The plurality of sensors 230 can also include an exhaust gas pressure, inlet/outlet NOx, tire pressure, fuel quality, and environmental sensors for extended diagnostics and predictive maintenance. The predictive maintenance configurations decrease unplanned failures. For example, logged SPN/FMI sequences and live telemetry feed pattern recognition and ML pipelines to generate health scores, failure timelines, and recommendations, helping fleets service components before failure and reducing breakdowns.

The plurality of sensors 230 acquires vehicle data and feeds the data (or signals) to the ECU 220, which converts the data into SPN values. The ECU 220 transmits the PGNs containing the SPN/FMI data to the vehicle diagnostic apparatus 240. The ECU 220 also compares the sensor readings against calibrated thresholds, detecting a DTC when the reading is outside an acceptable threshold. The ECU 220 can also activate the MIL when a DTC is detected. As explained further below, the ECU 220 can clear a DTC upon receiving a code-clear command and the vehicle satisfying one or more operating criteria. The ECU 220 can also receive commands from the remote device to initiate and monitor parked regeneration cycles before allowing a code clearing. The ECU 220 can also use the DPF temperature and soot sensors to initiate and monitor parked regeneration cycles before allowing a code clearing. The ECU 220 can also transmit an acknowledgement (success or denial) to the vehicle diagnostic apparatus 240, which can log the acknowledgement with a GPS coordinate and timestamp.

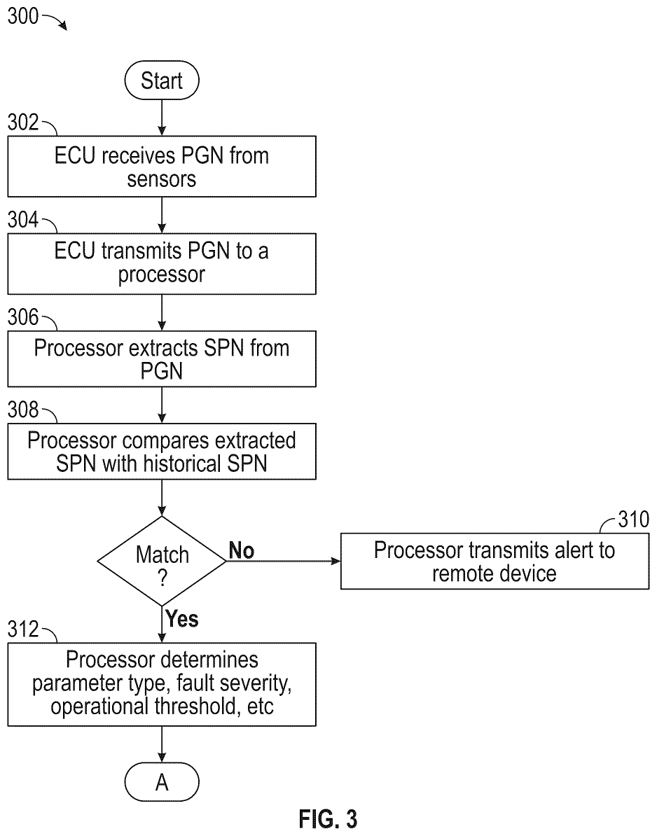

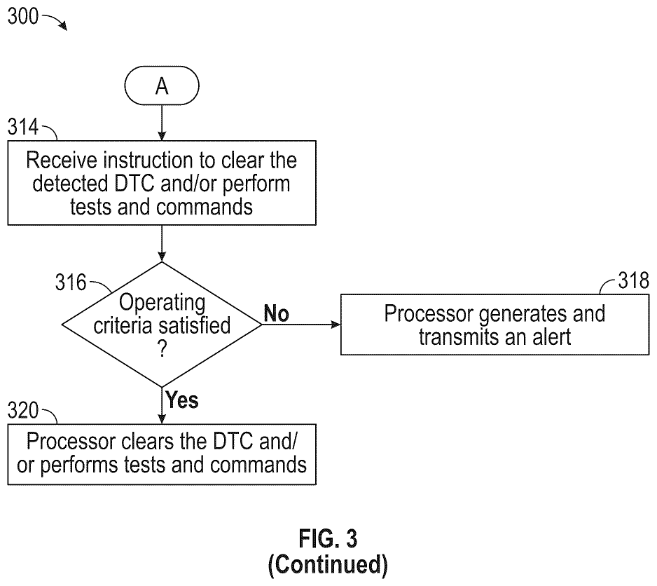

With reference to FIG. 3, a flow chart of an embodiment of a process 300 for diagnosing and clearing diagnostic trouble codes is illustrated. The process can begin at step 302 where the ECU receives signals from one or more sensors, which the ECU processes and encodes with PGNs. At step 304, the ECU transmits the PGNs to the vehicle diagnostic apparatus for diagnostics. The processor of the vehicle diagnostic apparatus decodes the PGNs and extracts the SPNs at step 306. Next, the processor compares the extracted SPNs with a parameter database at step 308. If the processor does not detect a match with the parameter database, the processor can transmit an alert to a remote device at step 310, indicating that an unknown issue may be detected. If the processor detects a match, it determines the parameter type, fault severity, and/or operational thresholds at step 312. The processor can then transmit the detected parameter type, fault severity, and/or operational thresholds to a remote device and/or server for review, and the user can provide an instruction to clear the detected DTC. Then, at step 314, the processor receives the instruction to clear the detected DTC. Additionally, or alternatively, the processor can receive instructions to perform tests and/or commands. At step 316, the processor determines whether one or more operating criteria of the vehicle are satisfied.

The operating criteria can include vehicle speed, where the operating criteria are not satisfied if the vehicle speed is greater than 0 miles per hour (e.g., the vehicle is not stationary). Additionally, or alternatively, the operating criteria can include engine RPM, where the operating criteria are not satisfied when the vehicle is in a Key On Engine Off (KOEO) state and the engine RPM is greater than the idle threshold (e.g., the vehicle is not stationary). Additionally, or alternatively, the operating criteria can include engine operating state, where the operating criteria are not satisfied if the gear is not in a neutral or parked state, or the accelerator is in an active state. Additionally, or alternatively, the operating criteria can include DPF soot loading percentage, where the operating criteria are not satisfied if the detected soot level is greater than a preconfigured minimum (e.g., more than 50%, 55%, 60%, 65%, 70%, 75%, 80%, 85%, 90%, or any combination thereof). Additionally, or alternatively, the operating criteria can include DEF tank level, where the operating criteria are not satisfied if the SCR conversion efficiency is less than a preconfigured threshold. Additionally, or alternatively, the operating criteria can include DPF temperature, where the operating criteria are not satisfied if the regeneration state and/or thermal conditions are not validated (e.g., not acceptable). Additionally, or alternatively, the operating criteria can include emissions readiness indicators, in which the operating criteria are not satisfied if the oil pressure is above or below an acceptable threshold. Additionally, or alternatively, the operating criteria can include coolant temperature, where the operating criteria are not satisfied if the temperature is above or below an acceptable threshold. Additionally, or alternatively, the operating criteria can include boost pressure, where the operating criteria are not satisfied if the turbo or fuel system has an abnormal reading. Additionally, or alternatively, the operating criteria can include the MIL status, in which the operating criteria are not satisfied if the MIL status is activated and the associated SPN/fault conditions have not naturally resolved (e.g., post-repair or regeneration). Additionally, or alternatively, the operating criteria can include blocklisted SPN indicators, in which the operating criteria are not satisfied if the detected SPNs (or faults) match any SPNs (or faults) on a blocklist. Additionally, or alternatively, the operating criteria can include an attempt counter within an attempt window, in which the operating criteria are not satisfied if the number of attempted clears within a predetermined (or predefined) timeframe is more than a threshold amount (e.g., more than N attempts per timeframe). Additionally, or alternatively, the operating criteria can include an inter-attempt interval, in which the operating criteria are not satisfied if a predetermined amount of time has not passed since the last clear (e.g., greater than or equal to 10 minutes, 15 minutes, 20 minutes, 25 minutes, 30 minutes, 35 minutes, 40 minutes, 45 minutes, 50 minutes, 55 minutes, 60 minutes, 90 minutes, 120 minutes, 150 minutes, 180 minutes, or any combination thereof). Additionally, or alternatively, the operating criteria can include the time since regeneration (or after-treatment reset), in which the operating criteria are not satisfied if the required parked regeneration or after-treatment reset has not been completed. Additionally, or alternatively, the operating criteria can include the user role, in which the operating criteria are not satisfied if the requester lacks the required clearing permission. Examples of authorized requestors can include fleet managers or administrators. In some instances, drivers or mechanics are not authorized users.

Additionally, or alternatively, the operating criteria can include the authentication method, in which the operating criteria are not satisfied if the required authentication is not satisfied (e.g., PIN, biometric, or mobile application approval). For example, sensitive actions (e.g., DTC clear, parked regeneration, after-treatment reset, threshold override, OTA apply) require authenticated, role-authorized users. Roles may include driver, mechanic, fleet manager, and administrator. Authentication may be via PIN, biometric (on mobile), device-bound passkeys, or mobile app approval (push confirmation). In at least one embodiment, a mobile application or dashboard attaches a signed credential or session token to the command. The mobile app or dashboard attaches a signed credential or session token to the command. The device verifies token validity (expiration, signature) and checks the role against a local policy table synchronized from the server. Only authorized roles proceed to safety gates (speed/RPM/emissions/blocklist/temporal) and device health checks. If the gates pass, the device issues the ECU command; otherwise, it denies with a reason code. Each step records the requester's identity, role, authentication method, and decision outcome in a cryptographically signed log. In at least one embodiment, the vehicle must meet certain criteria in order to perform an on-board diagnostic test via cellular/Bluetooth communication, parked or forced regeneration, or aftertreatment resets. The user can initiate actions such as clearing codes, aftertreatment filter resets, or requesting parked/forced regeneration.

Additionally, or alternatively, the operating criteria can include the request origin, in which the operating criteria are not satisfied if the origin of the request is not authorized. For example, if the origin is via a cellular network (e.g., remote cellular device or cloud server), the origin is authorized. However, in some instances, if the origin is local, short-range, or near field, the origin is not authorized. Additionally, or alternatively, the operating criteria can include the connectivity state, in which the operating criteria are not satisfied if the vehicle diagnostic apparatus is offline. In such instances, the events are queued, the local gates are applied, and the devices are later synced when online. In some embodiments, when connectivity is unavailable, the vehicle diagnostic apparatus can continue diagnostics and gate evaluation locally and store logs in a secure storage with cryptographic signatures.

If one or more operating criteria are not satisfied, the processor can generate an alert and transmit it to a remote device (or server) at step 318 for user review. On the other hand, if one or more operating criteria are satisfied, the processor can clear the DTC in the ECU at step 320. For example, the processor can send an instruction to the ECU to clear the DTC. In at least one example, if a DTC is detected and the MIL is activated, the driver of the vehicle can pull off the road to address the issue. Once the user of the remote device (or server) has reviewed the issue and determines that it can be addressed, the user can send an instruction to the processor of the vehicle diagnostic apparatus to clear the code and allow the vehicle to continue operating without the ECU terminating operation because of the code. Optionally, the user of the remote device (or server) can transmit a signal, alert, or message to the driver of the vehicle to immediately take the vehicle to a mechanic to address the issue. This configuration advantageously allows drivers of vehicles to safely remove the vehicle from the road (e.g., a highway or interstate) and allows them to quickly address the issue. Unlike the current technology, the present disclosure prevents the vehicle from being stranded on the road (or the shoulder of the road), which presents significant safety concerns and adversely affects traffic. Additionally, or alternatively, at step 320, the processor can perform tests and/or commands.

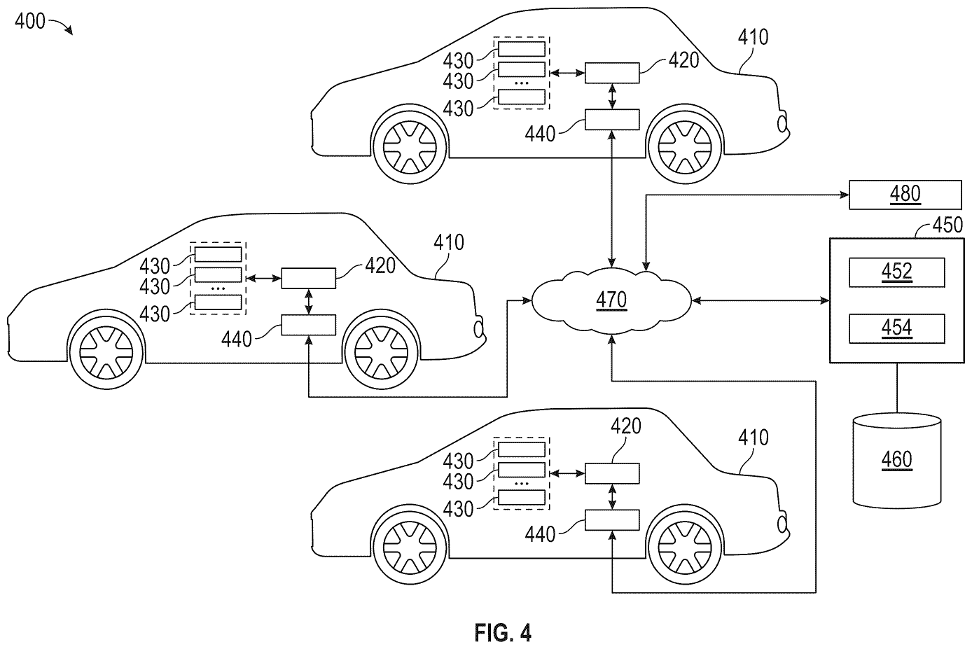

Turning to FIG. 4, a simplified block diagram of an embodiment of a system 400 for managing vehicle diagnostics in a fleet is shown. The system 400 includes a plurality of vehicles 410, one or more servers 450, and one or more remote devices 480 that are communicatively connected via a network 470. The vehicles 410 have a plurality of sensors 430 that are communicatively coupled to an ECU 420. The ECUs 420 are communicatively coupled to a vehicle diagnostic apparatus 440. Consistent with the principles previously described herein, the vehicle diagnostic apparatuses 440 can be connected to the ECUs 420 via a J1939 CAN bus through the OBD-II or 9-pin connector. The vehicle diagnostic apparatuses 440 can have a communications interface (or transceiver) that is configured to transmit and receive data over the network 470. The network 470 can be a telecommunications network (e.g., a cellular network, the Internet, a computer network, etc.).

In general, the ECUs 420 can collect the sensor data, manage DTCs, and control emissions systems. The one or more servers 450 can be configured to provide fleet-level (or system-wide) analytics, OTA updates, and role-based access control. The remote devices 480 can be configured to execute software (or mobile applications) and dashboards for user interaction. The remote devices 480 can be configured to have role-tailored views. For example, the remote device 480 can be configured with a driver view that allows viewing code, MIL status, emissions readiness, and basic recommendations, but does not allow clearing codes. In at least one embodiment, full (or complete) user access can be granted to a limited user. For example, a limited user can acquire full (or complete) user access for a limited time if the full user is unavailable. A timestamp and notification are logged and sent to the administrator when complete access is granted. The remote devices 480 can be configured to have a mechanic or administrator view, which provides complete fault lists, SPN/FMI details, regeneration controls, code-clearing (subject to gates), and logs export. The remote devices 480 can be configured to have a fleet manager view, which enables vehicle health scoring, fault timelines, GPS correlation, alert queues, policy management (thresholds, blocklists), and OTA rollout status. The health scores can include gauges or heatmaps that indicate the vehicle's condition. The timelines can include fault events mapped against routes; click through to log details. The recommendations can include contextual prompts (e.g., “Service within 48 hours,” “Initiate parked regeneration”). Audit tools can include the export of tamper-evident logs for compliance and warranty.

As previously explained, the ECUs 420 can encode the sensor data into PGNs that contain SPNs and FMIs, and the vehicle diagnostic apparatuses 440 can listen to the CAN frames broadcast by the ECUs 420. The vehicle diagnostic apparatuses 440 can parse the PGNs and detect active and previously active DTCs, evaluate emissions readiness (e.g., MIL status, permanent codes, warm-up cycles), and monitor live parameters for trend analysis. The vehicle diagnostic apparatuses 440 can transmit data to the servers 450. For example, the vehicle diagnostic apparatuses 440 can transmit diagnostic events (e.g., DTC reads, clears, regeneration requests), live telemetry (e.g., speed, RPM, coolant temperatures, emissions parameters, etc.), metadata (e.g., timestamps, GPS location, user identity, engine status, etc.), and logs that can be cryptographically signed for tamper-proof integrity. The one or more servers 450 can store the logs in a database 460 for compliance and auditing. The one or more servers 450 can perform analytics to detect abnormal parameter drift and predict vehicle failures. The one or more servers 450 can also generate health scores and maintenance recommendations. The one or more servers 450 can also apply cloud-side rules for generating alerts and notifications. In some embodiments, the one or more servers 450 can have a pattern recognition algorithm 452 and a trained model 454 to perform predictive analytics. The one or more servers 450 can generate fault code analysis and diagnostics with artificial intelligence (AI) generated diagnostics/fault troubleshooting steps, identifying potential causes and providing possible solutions that will be sent to the remote device 480.

The one or more remote devices 480 can display the codes and emissions status to a user on a graphical user interface. The one or more remote devices 480 can also be configured to initiate actions (e.g., clear codes, parked regeneration, after-treatment resets, etc.). The one or more remote devices 480 can also be configured to receive alerts and recommendations concerning the codes associated with the vehicles 410. In one embodiment, an authorized user can initiate an instruction to clear a code via a mobile application or dashboard on the one or more remote devices 480. When the corresponding vehicle diagnostic apparatuses 440 receive the instructions via the network 470, the vehicle diagnostic apparatuses 440 can determine whether the relevant operating criteria are satisfied (e.g., vehicle speed, RPM, emissions thresholds, blocklist SPNs, MIL status, and attempt limits). When the operating criteria are satisfied, the vehicle diagnostic apparatus 440 transmits the instruction to the corresponding ECU 420. In some embodiments, the ECU 420 can perform its own validation of the operating criteria to determine whether to clear the codes. In other embodiments, the ECU 420 clears the codes upon receiving the instructions. The vehicle diagnostic apparatus 440 can log the outcome (e.g., code cleared or not cleared) with GPS, timestamp, and/or the engine state. The vehicle diagnostic apparatus 440 can also transmit the logged outcomes to the server 450 for audit and compliance purposes.

The one or more servers 450 can also be configured to push firmware and configuration updates (e.g., blocklists and thresholds) to the vehicle diagnostic apparatuses 440. The one or more servers 450 can also authenticate the updates and create a fail-safe environment (e.g., dual-partition rollback). In some embodiments, trigger conditions can prompt a fail-safe operation. Non-limiting examples of trigger conditions can include device anomalies (watchdog resets, data corruption, storage errors), hardware faults (sensor bus error, power rail instability), and security failures (signature mismatch, authentication anomalies). Protective actions can be taken in response, including restricting sensitive information (e.g., temporarily blocking clearing/regeneration/reset until secondary verification), enacting passive monitoring mode (e.g., continue read-only diagnostics and logging), enacting emergency notifications (e.g., sending alerts to fleet admin with fault details and device status), and providing self-check and recovery (e.g., attempting re-validation; if unresolved, rollback firmware/config to last known good; log and sync outcome).

In some embodiments, the vehicle diagnostics apparatus 440 includes an OTA client executed by the processor and a communication module configured to connect to a remote update service via the network 470. The OTA client periodically polls the server 450 for available updates or responds to a server-initiated assignment. Update artifacts may include (i) a firmware image and (ii) one or more configuration bundles containing threshold values, blocklists, parser definitions, and policy rules. The configuration bundles can include critical parameter blocklists (e.g., SPN lists and associated policies), diagnostic thresholds (e.g., idle RPM, soot %, DEF %, SCR efficiency %), parser definitions (e.g., PGN/SPN/FMI mappings and semantic labels), alerting policies (e.g., severity levels, notification channels), and temporal gates (e.g., attempt window size, min inter-attempt interval). The server 450 distributes configuration versions, and the vehicle diagnostics apparatus 440 applies them atomically. Each parameter change can be recorded with a version, effective time, and provenance for a verifiable audit trail. A non-limiting example of a critical parameter blocklist is reflected below in Table 1. In at least one embodiment, when attempting to clear a fault code (e.g., permanent or critical fault code), a warning message can be displayed to notify the users that possible engine (or component) damage or failure can occur. In one example, a “Do you wish to proceed?” message may appear. A timestamp will be stored during the fault code clearing function submission.

TABLE 1

| Parameter | Purpose | Threshold |
|---|---|---|
| Engine speed (RPM) | Idle check | Deny if RPM > configured |
| | | idle (e.g., ≤700-800 RPM |
| | | illustrative) |
| Vehicle speed | Motion check | Deny if speed >0 mph |
| Oil pressure | Engine health | Deny if outside the |
| | | calibrated safe band |
| Coolant temperature | Overheat/thermal | Deny if above or below |
| | | the acceptable range |
| DPF soot level (%) | Emissions safety | Deny if soot ≥~70% |
| | | (illustrative; stored limit |
| | | configurable) |
| DEF tank level (%) | SCR readiness | Deny if DEF ≤~25% |
| | | (illustrative; |
| | | configurable) |
| SCR conversion | NOx reduction | Deny if efficiency is below |
| efficiency (%) | | the configured threshold |
| DPF inlet/outlet | Regen validation | Deny clearing until |
| temperature | | validated regen state |
| Boost pressure | Turbo/fuel diagnosis | Deny if abnormal |
| | | readings persist |
| MIL status | Emissions signaling | Deny if MIL is ON and |
| | | associated faults are not |
| | | naturally resolved |
| Active SPN | Unresolved fault | Deny if unresolved active |
| placeholder | catch-all | SPN persists |

The vehicles 410 can also include tire pressure sensors, fuel quality sensors, environmental sensors, and hybrid/EV sensors. For example, low tire pressure can be co-correlated with fault events and can be included in the blocklist if safety-critical. Fuel quality (or water-in-fuel) can identify an injector or combustion anomalies, which can raise alert severity. Environmental sensors (e.g., ambient temperature, pressure, humidity, etc.) can provide context for thermal/boost deviations. Hybrid/EV parameters (e.g., battery SoC, pack temperatures, charging events) can be added to the blocklist for EV safety, and clearing can be denied when unsafe states are detected. The sensors are sampled by the ECU 420 (or auxiliary controllers), encoded into SPNs, and broadcast as PGNs. The vehicle diagnostic apparatus 440 ingests them into the parameter database, applies gate logic, and uses them in analytics and recommendations. This configuration advantageously allows fleets to enable or disable optional sensors and assign policy impact to them.

The communication between the vehicle diagnostics apparatus 440 and the one or more servers 450 can be end-to-end encrypted. For example, a mutually authenticated, encrypted channel (e.g., TLS with device certificates). BLE local operations can be tunneled through secure sessions or app-level cryptography. Authorized BLE sessions (with app-level authentication and role checks) can be permitted for code reads/clear and regeneration when safety gates pass, even if the request originates from a local or short-range source. Sensitive records (e.g., user identity, GPS coordinates, command outcomes, ECU acknowledgements) can be encrypted at rest on the vehicle diagnostics apparatus 440 and in the databases 460. Keys can be stored in a protected keystore on the vehicle diagnostics apparatus 440, and the server-side access can follow role-based policies. Each log record can include a signature or hash that the server 450 verifies upon ingest to ensure tamper evidence. Firmware/configuration bundles can be signed by a trusted user. The vehicle diagnostics apparatus 440 can verify signatures before installation, and invalid or mismatched signatures can cause immediate abort and rollback.

In at least one embodiment, the vehicle diagnostics apparatus 440 transmits its current version, hardware profile, and role authorization to the server 450. The server 450 returns an assignment if policy permits. The vehicle diagnostics apparatus 440 downloads the artifact(s) over a secure channel and computes checksum(s) to confirm integrity before staging. The vehicle diagnostics apparatus 440 verifies a digital signature associated with the artifact using device-resident or server-provisioned public keys. The artifact is written to a non-active system partition or to a configuration store in secure storage. After installation, the vehicle diagnostics apparatus 440 reboots into the non-active partition (firmware case) or reloads configuration parameters (configuration case) and executes a validation routine. The vehicle diagnostics apparatus 440 reports success/failure and current state to the server 450, updating the rollout status for fleet visibility. Additionally, to prevent bricking or misconfiguration, the vehicle diagnostics apparatus 440 implements a dual-partition (A/B) or transactional configuration scheme. If post-update validation fails—e.g., boot failure, watchdog reset, integrity mismatch, or critical fault detection—the vehicle diagnostics apparatus 440 automatically reverts to the last known good partition (or prior configuration snapshot). Rollback events are logged with timestamp, cause, and version identifiers and are synchronized to the server 450 for audit.

The one or more servers 450 can enable continuous improvement of the diagnostics and telematics system 400 without requiring physical access to the vehicles 410. The one or more servers 450 can also be configured to receive vehicle data (e.g., SPN/FMI data, DTC states, emissions readiness, live telemetry, GPS), which can be used for compliance monitoring, predictive analytics, and fleet health scoring. In some embodiments, the one or more servers 450 can receive analytic inputs (e.g., speed, RPM, temperatures, pressures, SPN/FMI, occurrence counts, recency, and emissions readiness indicators and regeneration outcomes). The one or more servers 450 can execute a pattern recognition model to detect anomalous drifts (e.g., rising coolant under constant load; declining boost under acceleration). The one or more servers 450 can perform predictive maintenance that assigns health scores and recommended actions (e.g., “Inspect turbo within 48 hours”). The one or more servers 450 can also compute per-vehicle or fleet-wide threshold adjustments (idle RPM bounds, soot/DEF limits, alert severities). Updates can be distributed via OTA configuration (as described herein) and logged with version control. In at least one embodiment, a trained model detects parameter drifts and dynamically tunes thresholds (e.g., idle RPM bounds, soot/DEF limits), improving diagnostic fidelity across varying loads, climates, and vehicle aging. The one or more servers 450 can also be configured to transmit alerts, fault descriptions, health scores, and/or recommended actions to the one or more remote devices 480. Consistent with the principles previously described, the one or more servers 450 can transmit commands to the vehicle ECU 420 to perform various diagnostic functions (e.g., forced aftertreatment regenerations, aftertreatment filter resets, and DTC clearing).

In certain embodiments, the system 400 can be configured to exchange diagnostic and telemetry data with external fleet telematics platforms and maintenance workflows via secure APIs, including, but not limited to, fleet systems, DVIR tools, maintenance schedulers, and insurance risk-scoring modules. Integrations may support bidirectional sync of fault states, service tickets, and inspection results.

With continued reference to FIG. 4, in some embodiments, the system 400 can use a trained model 454 and pattern recognition algorithm 452 to identify abnormal parameter behavior, forecast early failures, and adjust diagnostic thresholds in real time for both individual vehicles and fleets. The trained model 454 can analyze sequences of parameter group numbers (PGNs) that include suspect parameter numbers (SPNs) and failure mode identifiers (FMIs) broadcast by the ECU, evaluating temporal relationships and context such as vehicle speed, engine RPM, coolant and oil temperatures, emissions readiness indicators, and malfunction indicator lamp (MIL) status. The pattern recognition algorithm 452 can analyze decoded SPN/FMI sequences from PGNs, emissions readiness indicators (permanent codes, MIL on/off, warm-up cycles), and live telemetry such as vehicle speed, engine RPM, coolant temperature, oil pressure, diesel particulate filter (DPF) soot loading, diesel exhaust fluid (DEF) tank level, selective catalytic reduction (SCR) conversion efficiency, and turbo boost pressure. The inputs can be sampled from the ECU 420 and may be supplemented with GPS coordinates and timestamps from the vehicle diagnostic apparatus 440 for geospatial correlation. Artificial intelligence (AI) can be leveraged through the trained model 454 and pattern-recognition algorithm 452 to predict engine and component failures before they occur. By continuously analyzing historical fault codes, sensor data, operating conditions, and maintenance records, the system can identify patterns that indicate early signs of wear or malfunction. When a potential failure is detected, the AI can present clear, step-by-step diagnostic procedures-such as pinpoint tests, probable root causes, and recommended repair actions-allowing technicians and fleet managers to make faster, more accurate repairs, reduce unplanned downtime, and extend overall equipment life.

The processor (local or cloud-side via server) can extract structured features across different axes. For example, one axis can include point features (per frame or interval), such as normalized SPN values, categorical encodings of active FMIs, MIL state, and role/permission context for actions. Another axis can be temporal features (sequence-based), including rolling means, variances, exponentially weighted trends, inter-event intervals, run-lengths of consecutive out-of-range readings, and lagged correlations (e.g., boost versus RPM under load). And another axis can involve regime and change-point features, such as cumulative-sum residuals and drift indicators signaling shifts from previous operating regimes (e.g., rising coolant under constant load; declining boost during acceleration).

The trained model 454 can include sequence models that operate over ordered SPN/FMI windows to classify evolving fault patterns and assign short-term failure probabilities. The trained model 454 can also use tabular gradient models for heterogeneous snapshot features (such as aggregates, thresholds, counters, and blocklist hits), providing calibrated risk scores and feature importance, improving explainability. Additionally, the trained model 454 can incorporate unsupervised anomaly detectors to identify novel, out-of-distribution combinations of SPNs and telemetry that do not match historical patterns but could pose safety or compliance risks. The outputs may include both binary events (such as alert/no-alert, allow/deny clear) and continuous values (such as health score, risk percentile, time-to-service estimate). Model training can be carried out using historical logs captured by the vehicle diagnostic apparatus and synchronized with the server and database. Labeled outcomes may include confirmed repairs, component replacements, successful or failed regenerations, derate events, and breakdowns. The server 450 can compile SPN/FMI trajectories, occurrence counts, recency statistics, and emissions indicators, then create models tailored to fleet, vehicle class, engine family, or climate region. At scheduled intervals, the logs can be reviewed to improve the pattern recognition model, which can then be sent to the devices as an updated model and/or configuration bundle. Artificial intelligence (AI) can be used to leverage the trained model 454 to analyze engine sensor data, fault codes, and operating trends to detect early signs of component wear or system degradation. By comparing real-time data against learned failure patterns, the system can predict likely engine issues before a fault becomes critical and recommend targeted diagnostic steps. This predictive approach improves troubleshooting accuracy, reduces unplanned downtime, and enables proactive maintenance based on actual engine behavior rather than fixed service intervals.

The pattern recognition algorithm 452 can process PGNs to extract SPNs/FMIs, compute point, temporal, and change-point features, and update counters (such as clear attempts per window and inter-attempt intervals). The pattern recognition algorithm can also apply the trained model to generate event likelihoods and health scores, as well as detect abnormal parameter drift. Additionally, the pattern recognition algorithm 452 can evaluate safety gates before sensitive actions (like remote DTC clear), considering factors such as vehicle speed equal to 0 mph, engine RPM at or below idle, SPNs not on a critical blocklist, inter-attempt time at or above the configured minimum, and attempt count within the specified window. The pattern recognition algorithm 452 can also log the requester's identity, role, authentication method, decision outcome, and GPS/timestamp in a tamper-evident record. To account for vehicle aging, usage patterns, and environmental variability, thresholds (e.g., idle RPM bands, DPF soot limits, DEF level minima, SCR efficiency bounds) can be dynamically adjusted using learned baselines. The trained model 454 can detect sustained parameter drifts and recalibrate bounds (or thresholds) using rolling statistics or Bayesian updates, subject to fleet-level policy constraints. Updates to blocklists and thresholds can be distributed over-the-air via the server and applied with role-based authorization. Using artificial intelligence (AI), the pattern-recognition algorithm 452 analyzes engine sensor data, fault histories, and performance trends to identify recurring behaviors that signal developing failures. By matching real-time engine data to known failure patterns, the system can predict component issues before they cause breakdowns and guide technicians toward the most likely root cause. This enables faster diagnostics, reduced downtime, and a shift from reactive repairs to proactive, condition-based maintenance.

The processor (local or cloud-side via server) can calculate multi-factor health scores and create failure timelines that link fault events with GPS data and operational conditions. The scoring system can prioritize recent abnormal SPN/FMI patterns, severity of emissions-related indicators (e.g., MIL active with unresolved faults), and consistency across different regimes (idle, cruise, load). The vehicle diagnostic apparatus 440 can generate recommendations (e.g., “Initiate parked regeneration,” “Inspect turbo within 48 hours,” or “Service DEF/SCR system”) and send them to the ECU 420, remote device 480, or both. Each alert or action can include a structured rationale such as top contributing SPNs/FMIs, drift magnitude, gate rationale (e.g., blocked due to MIL active or SPN on blocklist), and confidence intervals. Decision artifacts can be cryptographically signed and stored locally and on the server 450 to create an immutable event history for warranty, compliance, and forensic investigations. The vehicle diagnostic apparatus 440 can also run lightweight models for quick gating and initial anomaly detection while sending data to a server for more detailed modeling and fleet-wide learning. When the communication interface cannot connect, the vehicle diagnostic apparatus 440 continues local diagnostics and gate evaluation, queues events, and synchronizes logs and model feedback once it is online.

In at least some embodiments, pattern recognition results can be linked to a configurable critical SPN blocklist that encodes emissions-safety and engine-protection rules (e.g., DPF soot level, DEF tank level, SCR efficiency, oil pressure, coolant temperature, boost pressure, MIL status, and a generic “Active SPN” placeholder). A final decision layer can block sensitive actions when detected faults match the blocklist, regardless of the model's short-term confidence, thereby enforcing conservative safety policies. Fault notifications can be prioritized using model-generated risk scores and policy heuristics (such as FMI severity, occurrence counts, and recency). Surpassing critical thresholds (e.g., DPF soot greater than or equal to a set limit) can trigger higher alerts, and user access levels determine which actions are available in the application or dashboard (view-only versus conditional clearing).

As used herein, the term “about” can be understood as the disclosed values varying by 20-25%, 15-20%, 10-15%, 5-10%, 1-5%, or any combination thereof from the listed values.

Moreover, for the purposes of the present disclosure, the term “a” or “an” entity refers to one or more of that entity. As such, the terms “a” or “an,” “one or more,” and “at least one” can be used interchangeably herein.

Additionally, the section headings herein are provided for consistency with the suggestions under 37 C.F.R. § 1.77 or to provide organizational cues. These headings shall not limit or characterize the invention(s) set out in any claims that may issue from this disclosure. Specifically, and by way of example, although the headings refer to a “Technical Field,” the claims should not be limited by the language chosen under this heading to describe the so-called field. Further, a description of a technology as background information is not to be construed as an admission that a particular technology is prior art to any embodiment(s) in this disclosure. Neither is the “Summary” a characterization of the embodiment(s) outlined in issued claims.

Furthermore, any reference in this disclosure to “invention” in the singular should not be used to argue that there is only a single point of novelty in this disclosure. Multiple embodiments may be set forth according to the limitations of the multiple claims issuing from this disclosure. Such claims accordingly define the embodiment(s) and their equivalents that are protected thereby. In all instances, the scope of such claims shall be considered on their own merits in light of this disclosure but should not be constrained by the headings set forth herein.

Moreover, the Abstract is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In addition, in the preceding Detailed Description, it can be seen that various features may be grouped in a single embodiment to streamline the disclosure. This method of disclosure is not to be interpreted as reflecting an intention that the claimed embodiments require more features than are expressly recited in each claim. Instead, as the claims reflect, the inventive subject matter lies in less than all features of a single disclosed embodiment. Thus, the following claims are incorporated into the Detailed Description, with each claim standing on its own as a separate embodiment.

What is claimed is:

1. A vehicle diagnostic apparatus comprising:
a transceiver in communication with an engine control unit (ECU) of a vehicle, wherein the transceiver receives signals from the ECU comprising parameter group numbers (PGNs); and
a processor in communication with the transceiver, wherein the processor is configured to:
extract suspect parameter numbers (SPNs) from the PGNs,
compare the extracted SPNs with historical SPNs stored in a database to determine a parameter type, a fault severity, an operation threshold, or any combination thereof,
generate an alert when a diagnostic trouble code (DTC) is detected based on the comparison,
transmit, via the transceiver, the alert to a remote device,
receive, via the transceiver, an instruction from the remote device to clear the DTC, and
clear the DTC based on one or more operating criteria being satisfied.

2. The vehicle diagnostic apparatus of claim 1, wherein the one or more operating criteria is satisfied when a speed of the vehicle is 0 miles per hour.

3. The vehicle diagnostic apparatus of claim 1, wherein the one or more operating criteria is satisfied when the vehicle is in a Key On Engine Off (KOEO) state and the engine RPM is 0.

4. The vehicle diagnostic apparatus of claim 1, wherein the one or more operating criteria is satisfied when the instruction to clear the DTC is received at least 30 minutes after a previous instruction to clear a DTC.

5. The vehicle diagnostic apparatus of claim 1, wherein the one or more operating criteria is satisfied when the instruction to clear the DTC is less than a threshold number within a predefined time period.

6. The vehicle diagnostic apparatus of claim 1, wherein the transceiver is in communication with the remote device via a short-range wireless network or a cellular network.

7. The vehicle diagnostic apparatus of claim 1, further comprising a global positioning system (GPS) module in communication with the processor, wherein the processor logs a location of the vehicle upon receiving the instruction from the remote device.

8. The vehicle diagnostic apparatus of claim 1, wherein the processor is further configured to perform one or more diagnostic tests based on the signals received from the ECU.

9. The vehicle diagnostic apparatus of claim 8, wherein transmission between the processor and the remote device is via a cellular network.

10. The vehicle diagnostic apparatus of claim 1, wherein the processor is further configured to transmit the PGNs and extracted SPNs to the remote device, and wherein the processor receives results from one or more diagnostic tests performed by the remote device and one or more commands associated with the results.

11. A method for diagnosing and clearing diagnostic trouble code (DTC), the method comprising:
receiving signals from an engine control unit (ECU) of a vehicle at a processor via a transceiver, wherein the signals comprise parameter group numbers (PGNs);
extracting, via the processor, suspect parameter numbers (SPNs) from the PGNs;
comparing, via the processor, the extracted SPNs with historical SPNs stored in a database to determine a parameter type, a fault severity, an operation threshold, or any combination thereof;
generating, via the processor, an alert when a diagnostic trouble code (DTC) is detected based on the comparison;
transmitting, via the transceiver, the extracted SPNs and the alert to a remote device;
diagnosing, via the remote device, vehicle issues based at least on the extracted SPNs;
receiving, via the transceiver, an instruction from the remote device to clear the DTC; and
clearing, via the processor, the DTC based on one or more operating criteria being satisfied.

12. The method of claim 11, wherein the one or more operating criteria is satisfied when a speed of the vehicle is 0 miles per hour.

13. The method of claim 11, wherein the one or more operating criteria is satisfied when the vehicle is an a Key On Engine Off (KOEO) state and the engine RPM is 0.

14. The method of claim 11, wherein the one or more operating criteria is satisfied when the instruction to clear the DTC is received at least 30 minutes after a previous instruction to clear a DTC.

15. The method of claim 11, wherein the one or more operating criteria is satisfied when the instruction to clear the DTC is less than a threshold number within a predefined time period.

16. The method of claim 11, wherein the transceiver is in communication with the remote device via a short-range wireless network or a cellular network.

17. The method of claim 11, further comprising logging a location of the vehicle via a global positioning system (GPS) module upon receiving the instruction from the remote device.

18. The method of claim 11, wherein transmission between the processor and the remote device is via a cellular network.

19. The method of claim 11, wherein the remote device utilizes artificial intelligence (AI) to diagnose vehicle issues.

20. The method of claim 11, further comprising transmitting, via the transceiver, the detected DTC to the database.
